(19) United States
(12) Patent Application Publication
(10) Pub. No.: US 2013/0155254 A1
(43) Pub. Date: Jun. 20, 2013

(54) IMAGING APPARATUS, IMAGE PROCESSING APPARATUS, AND IMAGE PROCESSING METHOD

(71) Applicant: FUJITSU LIMITED, Kawasaki-shi (JP)

(72) Inventors: Nobuyuki KANTO, Kobe (JP); Masayoshi Shimizu, Hadano (JP); Hiroyasu Yoshikawa, Akashi (JP); Yukio Hirai, Akashi (JP); Takuya Kamimura, Kobe (JP)

(73) Assignee: FUJITSU LIMITED, Kawasaki-shi (JP)

(21) Appl. No.: 13/664,912

(22) Filed: Oct. 31, 2012

(30) Foreign Application Priority Data
Dec. 19, 2011 (JP) 2011-277725

(51) Int. Cl. H04N 5/33

(52) U.S. Cl. 348/164; 348/E05.09

(57) ABSTRACT

An imaging unit has sensitivity to visible light and infrared light and captures an image. When the distribution of the color of each pixel in the image captured by the imaging unit is calculated, a deriving unit derives a predetermined feature amount indicating the range of the color distribution. An estimating unit estimates a lighting environment during imaging based on the feature amount derived by the deriving unit.

### CROSS-REFERENCE TO RELATED APPLICATIONS

This application is based upon and claims the benefit of priority of the prior Japanese Patent Application No. 2011-277725, filed on Dec. 19, 2011, the entire contents of which are incorporated herein by reference.

### FIELD

The embodiments discussed herein are directed to an imaging apparatus, an image processing apparatus, an image processing program, and an image processing method.

### BACKGROUND

An imaging apparatus, such as a digital camera that captures an image using visible light, has been known which is provided with an infrared cut filter, cuts infrared light, and captures an image using only visible light. In addition, an imaging apparatus has been known which includes an active sensor that emits infrared light to capture an image, does not include an infrared cut filter, and captures an image using visible light and infrared light. Furthermore, an imaging apparatus has been known which captures an image using visible light and infrared light and is used in, for example, a monitoring camera or an eye gaze detection apparatus. The color tone of the image captured using visible light and infrared light is changed due to an infrared light component, as compared to the image captured using only visible light.

However, when one imaging apparatus is used to capture both an image using visible light and an image using infrared light, a structure is considered in which an attachment mechanism for attaching or detaching the infrared cut filter to or from the imaging apparatus is provided. However, when the attachment mechanism is provided, the size and manufacturing costs of the imaging apparatus increase. In particular, an increase in the size of the apparatus causes problems in portable terminals with a camera, such as mobile phones or smart phones.

Therefore, a technique has been proposed in which the infrared cut filter is removed and signal processing using a matrix operation is performed to correct the color of the image captured using visible light and infrared light. However, the color tone of the image captured by the imaging apparatus without an infrared cut filter varies greatly depending on lighting conditions during imaging. Therefore, a technique for correcting the color of the captured image has been proposed. For example, a technique has been proposed which integrates R (Red), G (Green), and B (Blue) pixel values indicating the colors of each pixel of the captured image for each color, estimates a color temperature from the ratio of the integrated value of R to the integrated value of G (ΣR/ΣG) or the ratio of the integrated value of B to the integrated value of G (ΣB/ΣG), and performs color conversion in correspondence with the color temperature. In addition, a technique has been proposed in which an imaging apparatus is provided with a visible light sensor and a sensor only for ultraviolet light and infrared light and the sensor only for ultraviolet light and infrared light is used to measure the relative intensity of ultraviolet light and infrared light with respect to visible light, thereby estimating a light source.
Patent Literature 1: Japanese Laid-open Patent Publication No. 2006-094112
Patent Literature 2: Japanese Laid-open Patent Publication No. 2008-275582

### SUMMARY

According to an aspect of an embodiment, An imaging apparatus includes an imaging unit that has sensitivity to visible light and infrared light and captures an image; a deriving unit that, when a distribution of a color of each pixel in the image captured by the imaging unit is calculated, derives a predetermined feature amount indicating a range of the color distribution; and an estimating unit that estimates a lighting environment during imaging based on the feature amount derived by the deriving unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the structure of an imaging apparatus;

FIG. 2 is a diagram illustrating an example of the image of a color checker target captured by an imaging apparatus with an infrared cut filter;

FIG. 3 is a diagram illustrating an example of the image of the color checker target captured by an imaging apparatus without an infrared cut filter;

FIG. 4 is a diagram illustrating the spectral characteristics of light reflected from each color sample region of the color checker target;

FIG. 5 is a diagram illustrating an example of the spectral sensitivity characteristics of a general imaging element;

FIG. 6A is a diagram illustrating an example of the spectral sensitivity characteristics of the imaging apparatus with an infrared cut filter;

FIG. 6B is a diagram illustrating an example of the spectral sensitivity characteristics of the imaging apparatus without an infrared cut filter;

FIG. 7 is a diagram illustrating an example of the spectral characteristics of a reflector sample;

FIG. 8 is a diagram illustrating an example of the R, G, and B values of the images of the reflector sample captured by the imaging apparatus without an infrared cut filter and the imaging apparatus with an infrared cut filter.

FIG. 9A is a diagram illustrating an example of the image of trees captured in an incandescent lighting environment;

FIG. 9B is a diagram illustrating an example of the image of trees captured in a sunlight lighting environment;

FIG. 9C is a diagram illustrating an example of the image of trees captured in a fluorescent lighting environment;

FIG. 10A is a graph illustrating the chromaticity distribution of the image illustrated in FIG. 9A at xy chromaticity coordinates of an XYZ color system;

FIG. 10B is a graph illustrating the chromaticity distribution of the image illustrated in FIG. 9B at the xy chromaticity coordinates of the XYZ color system;

FIG. 10C is a graph illustrating the chromaticity distribution of the image illustrated in FIG. 9C at the xy chromaticity coordinates of the XYZ color system;

FIG. 11A is a diagram illustrating an example of the image of a river captured in the incandescent lighting environment;

FIG. 11B is a diagram illustrating an example of the image of the river captured in the sunlight lighting environment;

FIG. 11C is a diagram illustrating an example of the image of the river captured in the fluorescent lighting environment;

FIG. 12A is a graph illustrating the chromaticity distribution of the image illustrated in FIG. 11A at the xy chromaticity coordinates of the XYZ color system;

FIG. 12B is a graph illustrating the chromaticity distribution of the image illustrated in FIG. 11B at the xy chromaticity coordinates of the XYZ color system;

FIG. 12C is a graph illustrating the chromaticity distribution of the image illustrated in FIG. 11C at the xy chromaticity coordinates of the XYZ color system;

FIG. 13A is a diagram illustrating an example of an image overlooking the river which is captured in the incandescent lighting environment;

FIG. 13B is a diagram illustrating an example of the image overlooking the river which is captured in the sunlight lighting environment;

FIG. 13C is a diagram illustrating an example of the image overlooking the river which is captured in the fluorescent lighting environment;

FIG. 14A is a graph illustrating the chromaticity distribution of the image illustrated in FIG. 13A at the xy chromaticity coordinates of the XYZ color system;

FIG. 14B is a graph illustrating the chromaticity distribution of the image illustrated in FIG. 13B at the xy chromaticity coordinates of the XYZ color system;

FIG. 14C is a graph illustrating the chromaticity distribution of the image illustrated in FIG. 13C at the xy chromaticity coordinates of the XYZ color system;

FIG. 15A is a diagram illustrating an example of the image of an indoor exhibition captured in the incandescent lighting environment;

FIG. 15B is a diagram illustrating an example of the image of the indoor exhibition captured in the sunlight lighting environment;

FIG. 15C is a diagram illustrating an example of the image of the indoor exhibition captured in the fluorescent lighting environment;

FIG. 16A is a graph illustrating the chromaticity distribution of the image illustrated in FIG. 15A at the xy chromaticity coordinates of the XYZ color system;

FIG. 16B is a graph illustrating the chromaticity distribution of the image illustrated in FIG. 15B at the xy chromaticity coordinates of the XYZ color system;

FIG. 16C is a graph illustrating the chromaticity distribution of the image illustrated in FIG. 15C at the xy chromaticity coordinates of the XYZ color system;

FIG. 17A is a diagram illustrating an example of the image of food on the dish which is captured in the incandescent lighting environment;

FIG. 17B is a diagram illustrating an example of the image of the food on the dish which is captured in the sunlight;

FIG. 17C is a diagram illustrating an example of the image of the food on the dish which is captured in the fluorescent lighting environment;

FIG. 18A is a graph illustrating the chromaticity distribution of the image illustrated in FIG. 17A at the xy chromaticity coordinates of the XYZ color system;

FIG. 18B is a graph illustrating the chromaticity distribution of the image illustrated in FIG. 17B at the xy chromaticity coordinates of the XYZ color system;

FIG. 18C is a graph illustrating the chromaticity distribution of the image illustrated in FIG. 17C at the xy chromaticity coordinates of the XYZ color system;

FIG. 19A is a histogram illustrating the maximum value of the chromaticity distribution in the x direction for each type of light source;

FIG. 19B is a histogram illustrating the maximum value of the chromaticity distribution in the y direction for each type of light source;

FIG. 20A is a diagram illustrating the correction result of the image illustrated in FIG. 9A with a correction coefficient corresponding to an incandescent lamp;

FIG. 20B is a diagram illustrating the correction result of the image illustrated in FIG. 9B with a correction coefficient corresponding to sunlight;

FIG. 21 is a flowchart illustrating the procedure of an imaging process; and

FIG. 22 is a diagram illustrating a computer that executes an image processing program.

### DESCRIPTION OF EMBODIMENTS

However, for example, in the incandescent lamp, the intensity of an infrared region is higher than that of a visible region. On the other hand, in the fluorescent lamp, the intensity of an infrared region is lower than that of a visible region. Therefore, when the incandescent lamp is used for lighting during imaging, the amount of infrared light incident on the imaging apparatus is more than that when the fluorescent lamp is used for lighting during imaging, which results in an increase in the percentage of an achromatic color in the captured image. Therefore, when the incandescent lamp is used for lighting during imaging, the amount of color correction for the captured image needs to be more than that when the fluorescent lamp is used for lighting during imaging. However, in both the incandescent lamp and the fluorescent lamp, the color temperature is likely to be about 3000 K.

As such, in some cases, the color temperature is the same even in different lighting environments. Therefore, knowledge of a lighting environment during imaging is useful for appropriate color correction of the captured image. However, even when the color temperature is estimated from the ratio of the integrated value of R to the integrated value of G (ΣR/ΣG) or the ratio of the integrated value of B to the integrated value of G (ΣB/ΣG) in the captured image as in the related art, it is difficult to estimate the lighting environment. That is, in the related art, since color conversion is performed in correspondence with the estimated color temperature, it is difficult to perform appropriate color conversion and an image with insufficient color reproducibility is obtained.

In addition, it is considered that, when the sensor only for ultraviolet light and infrared light is provided in the imaging apparatus, the size and costs of the apparatus increase.

Preferred embodiments of the present invention will be explained with reference to accompanying drawings. However, the invention is not limited to the embodiments. In each embodiment, the contents of processes may be appropriately combined with each other without departing from the scope of the invention. Next, a case in which the invention is applied to an imaging system will be described.

### [a] First Embodiment

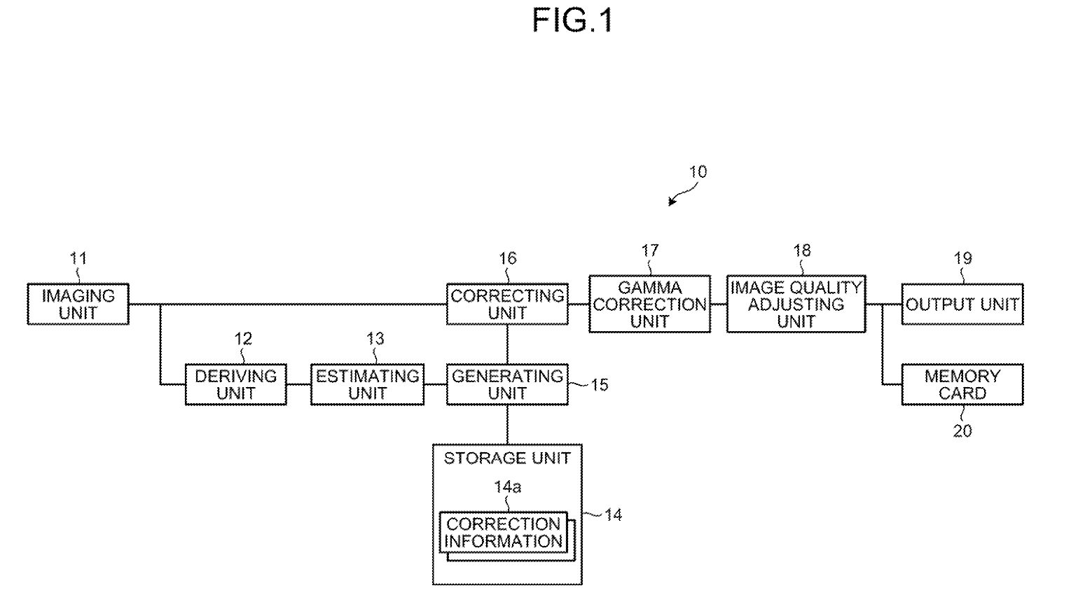

An imaging system according to a first embodiment will be described. FIG. 1 is a diagram illustrating an example of the structure of an imaging apparatus. An imaging apparatus 10 captures a still image or a moving image and is, for example, a digital camera, a video camera, or a monitoring camera. The imaging apparatus 10 may be a portable terminal with a camera. The imaging apparatus 10 includes an imaging unit 11, a deriving unit 12, an estimating unit 13, a storage unit 14, a generating unit 15, a correcting unit 16, a gamma correction unit 17, an image quality adjusting unit 18, an output unit 19, and a memory card 20.

The imaging unit 11 captures an image. For example, the imaging unit 11 includes an optical component, such as a lens, and an imaging element, such as a CCD (Charge Coupled Device) image sensor or a CMOS (Complementary Metal Oxide Semiconductor) image sensor arranged on the optical axis of the optical component. The optical component of the imaging unit 11 does not include an infrared cut filter and the imaging unit 11 has sensitivity to visible light and infrared light. In the imaging unit 11, visible light and infrared light are incident on the imaging element through the optical component. In the imaging element, R, G, and B color filters are arranged on a light receiving surface in a predetermined pattern so as to correspond to pixels. The imaging element outputs an analog signal corresponding to the amount of light received by each pixel.

The imaging unit 11 performs various kinds of analog signal processing including a noise removal process, such as correlated double sampling, and an amplifying process on the analog signal output from the imaging element. Then, the imaging unit 11 converts the analog signal subjected to the analog signal processing into digital data, performs various kinds of digital signal processing, such as a de-mosaic process, and outputs image information indicating the captured image. For each pixel in the image information, a value indicating a color is determined by a predetermined gradation in an RGB color space. The color tone of the image captured by the imaging unit 11 is changed by the influence of an infrared light component, as compared to the image captured using only visible light.

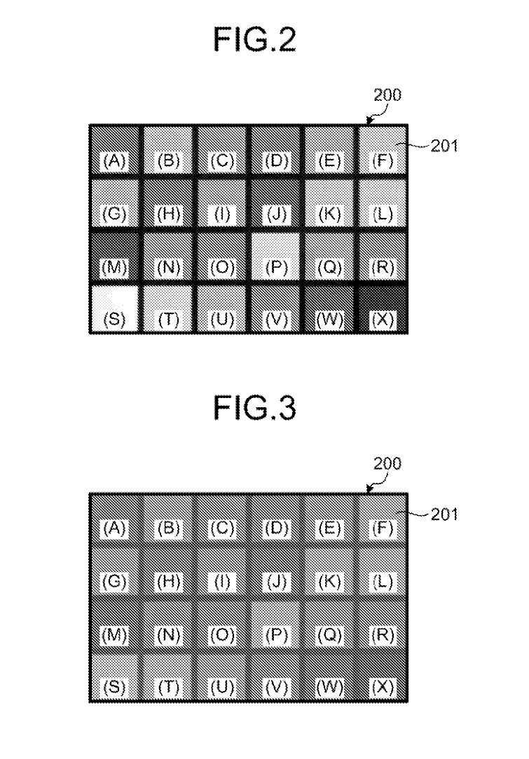

Next, an example of a change in the color tone will be described using the image of a color checker target manufactured by X-Rite Incorporated. FIG. 2 is a diagram illustrating an example of the image of the color checker target captured by an imaging apparatus with an infrared cut filter. FIG. 3 is a diagram illustrating an example of the image of the color checker target captured by an imaging apparatus without an infrared cut filter. As illustrated in FIGS. 2 and 3, a color checker target 200 includes 24 ((A) to (X)) rectangular color sample regions 201 including gray tone. In FIG. 2, a color tone is not changed, as compared to FIG. 3.

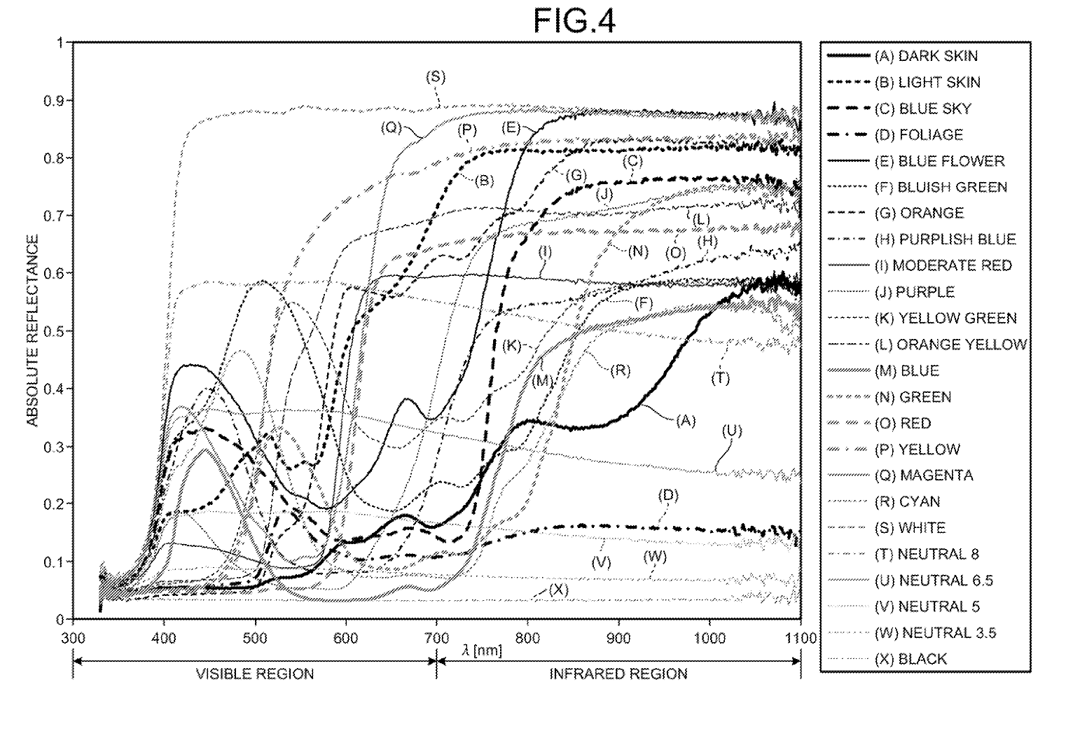

Light reflected from each color sample region 201 includes visible light and infrared light. FIG. 4 is a diagram illustrating the spectral characteristics of light reflected from each color sample region of the color checker target. FIG. 4 illustrates the spectral characteristics of light reflected from the color sample regions 201 so as to correspond to (A) to (X) given to the color sample regions 201. In addition, FIG. 4 illustrates the names of the colors of the color sample regions 201 so as to correspond to (A) to (X). For example, the color of the color sample region 201 represented by (A) is dark skin.

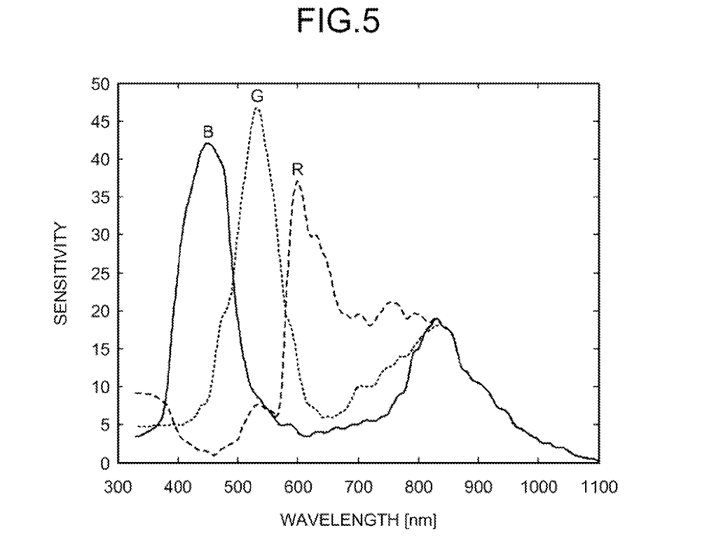

The imaging element has sensitivity to visible light and infrared light. FIG. 5 is a diagram illustrating an example of the spectral sensitivity characteristics of a general imaging element. As illustrated in FIG. 5, in the imaging element, each pixel has sensitivity to both the wavelength band of R, G, and B light components and the wavelength band of infrared light with a 700 nm or higher wavelength. Therefore, when both visible light and infrared light are incident on each of the R, G, and B color light receiving portions, the imaging element generates charge corresponding to the amount of infrared light received. The color tone of the captured image is changed by the influence of the charge corresponding to the amount of infrared light received.

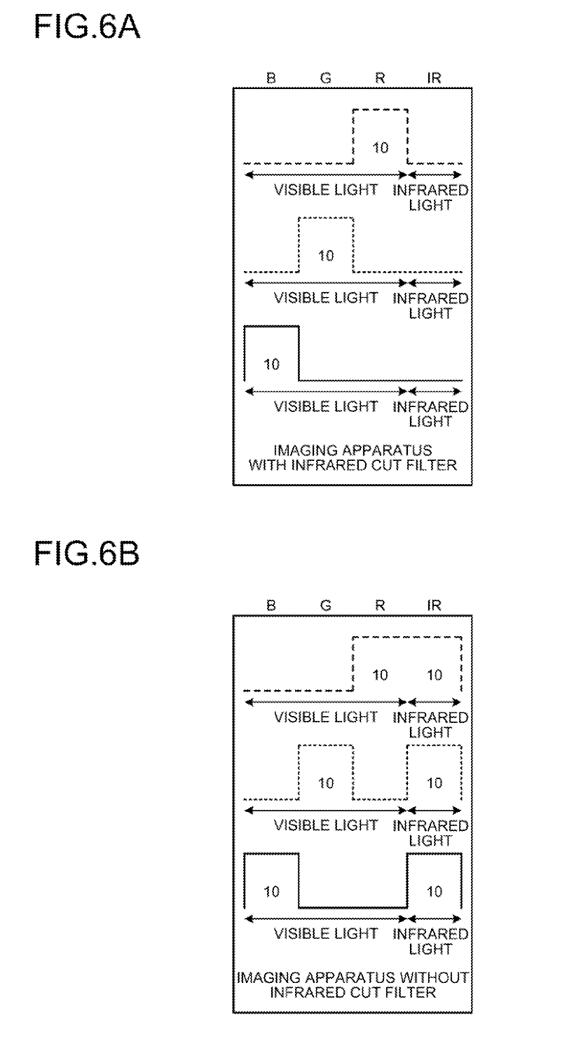

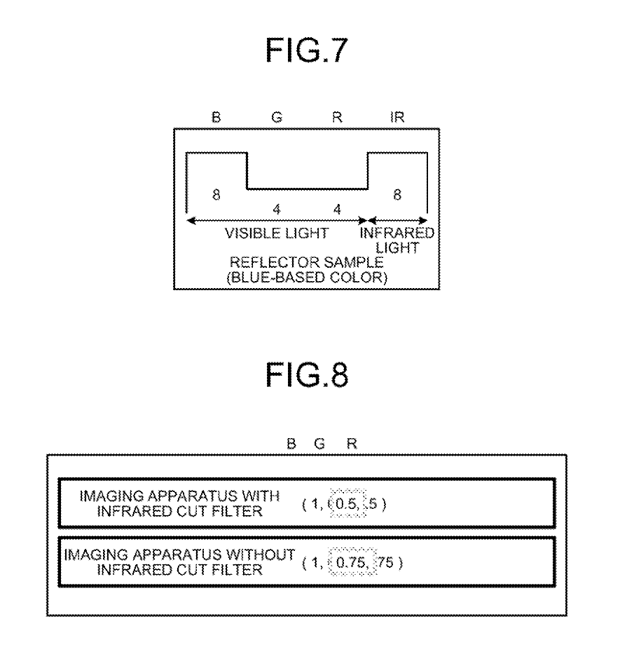

For example, the reason why the color tone of the image is changed when the infrared cut filter is not provided will be described in detail using a model which simplifies the spectral sensitivity characteristics illustrated in FIG. 5. FIG. 6A is a diagram illustrating an example of the spectral sensitivity characteristics of the imaging apparatus with an infrared cut filter. As illustrated in FIG. 6A, the imaging apparatus with an infrared cut filter has a sensitivity of “10” to R, G, and B light components and has a sensitivity of “0” to infrared light. FIG. 6B is a diagram illustrating an example of the spectral sensitivity characteristics of the imaging apparatus without an infrared cut filter. As illustrated in FIG. 6B, the imaging apparatus without an infrared cut filter has a sensitivity of “10” to R, G, and B light components and infrared light. It is assumed that the imaging apparatus with an infrared cut filter and the imaging apparatus without an infrared cut filter are used to capture the image of, for example, a blue-based reflector sample. FIG. 7 is a diagram illustrating an example of the spectral characteristics of the reflector sample. In the example illustrated in FIG. 7, it is assumed that the spectral characteristics of R and infrared wavelength bands are “8” and the spectral characteristics of G and B wavelength bands are “4”. FIG. 8 is a diagram illustrating an example of the R, G, and B values of the images of the reflector sample captured by the imaging apparatus without an infrared cut filter and the imaging apparatus with an infrared cut filter. FIG. 8 illustrates the normalized R, G, and B values.

The R, G, and B values of the image captured by the imaging apparatus with an infrared cut filter are obtained by integrating the product of the sensitivity to the R, G, and B light components illustrated in FIG. 6A and the blue-based sample illustrated in FIG. 7 for each color component. For example, the R, G, and B values of the image captured by the imaging apparatus with an infrared cut filter are calculated as follows:

R value=10×8=80

G value=10×4=40

B value=10×4=40

In the example illustrated in FIG. 8, the R, G, and B values of the image captured by the imaging apparatus with an infrared cut filter are normalized as the ratio of R:G:B=80:40:40=1:0.5:0.5.

In addition, the R, G, and B values of the image captured by the imaging apparatus without an infrared cut filter are obtained by integrating the product of the sensitivity to the R, G, and B light components and infrared light illustrated in FIG. 6B and the blue-based sample illustrated in FIG. 7 for each color component. For example, the R, G, and B values of the image captured by the imaging apparatus without an infrared cut filter are calculated as follows:

R value=10×8+10×8=160

G value=10×4+10×8=120

B value=10×4+10×8=120

In the example illustrated in FIG. 8, the R, G, and B values of the imaging apparatus without an infrared cut filter are normalized as the ratio of R:G:B=160: 120:120=1:0.75:0.75.

As illustrated in FIG. 8, a difference in the R, G, and B values of the image captured by the imaging apparatus without an infrared cut filter is less than a difference in the R, G, and B values of the image captured by the imaging apparatus with an infrared cut filter. That is, a change in the color tone of the image captured by the imaging apparatus without an infrared cut filter is more than a change in the color tone of the image captured by the imaging apparatus with an infrared cut filter and the color of the image captured by the imaging apparatus without an infrared cut filter is close to an achromatic color. As the sensitivity of the imaging apparatus to infrared light increases, the color of the captured image is closer to the achromatic color.

In general lighting, the intensity of infrared light with respect to visible light can be classified into three levels, that is, high, medium, and low levels. For example, an incandescent lamp includes a large amount of infrared light. In addition, sunlight includes a medium amount of infrared light that is less than that emitted from the incandescent lamp and is more than that emitted from a fluorescent lamp. The fluorescent lamp includes a small amount of infrared light.

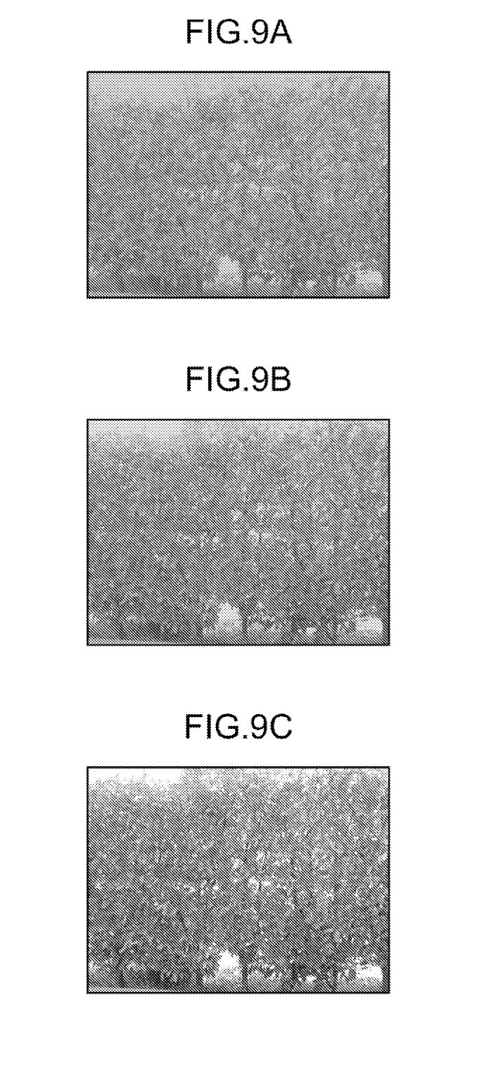

A change in the color tone of the image of an object which is captured using the incandescent lamp, sunlight, and the fluorescent lamp will be described. FIG. 9A is a diagram illustrating an example of the image of trees captured in an incandescent lighting environment.

FIG. 9B is a diagram illustrating an example of the image of trees captured in a sunlight lighting environment. FIG. 9C is a diagram illustrating an example of the image of trees captured in a fluorescent lighting environment. Among the incandescent lamp, sunlight, and the fluorescent lamp, the incandescent lamp has the largest amount of infrared light mixed and the fluorescent light has the smallest amount of infrared light mixed. Therefore, as illustrated in FIG. 9A, the color of the image captured using the incandescent lamp is close to an achromatic color. As illustrated in FIG. 9C, the image captured using the fluorescent lamp is close to the image captured by the imaging apparatus with an infrared cut filter.

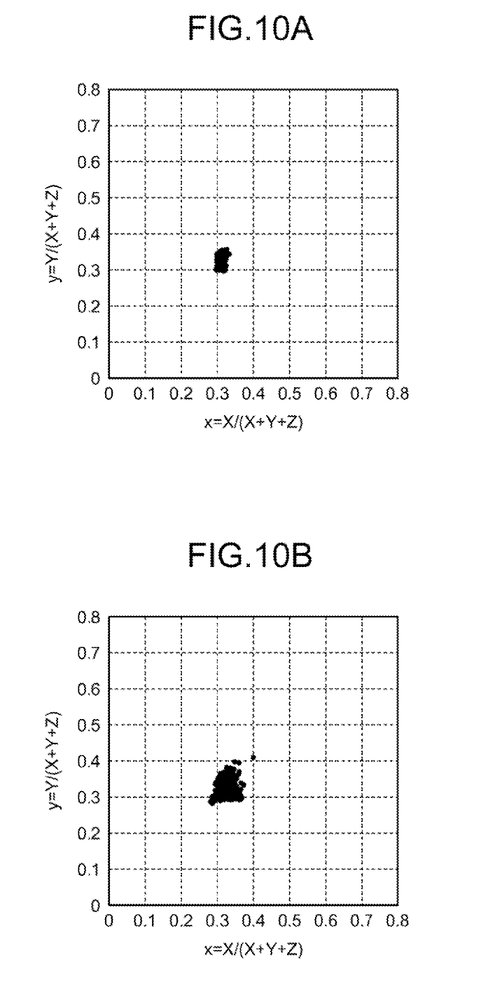

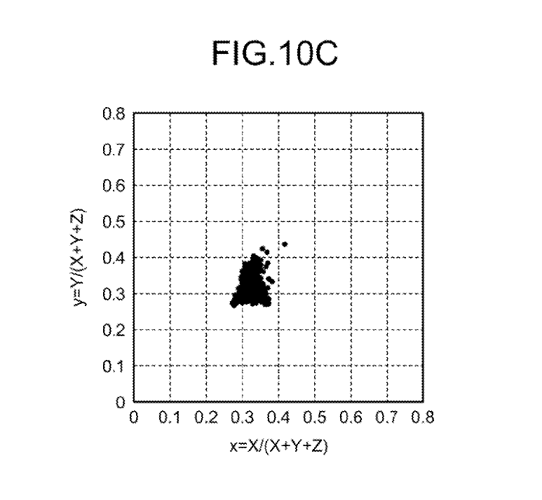

In order to clarify the difference among the color tones of the images illustrated in FIGS. 9A to 9C, the color tones are compared using the chromaticity distributions of the images illustrated in FIGS. 9A to 9C at the xy chromaticity coordinates of the XYZ color system. FIG. 10A is a graph illustrating the chromaticity distribution of the image illustrated in FIG. 9A at the xy chromaticity coordinates of the XYZ color system. FIG. 10B is a graph illustrating the chromaticity distribution of the image illustrated in FIG. 9B at the xy chromaticity coordinates of the XYZ color system. FIG. 10C is a graph illustrating the chromaticity distribution of the image illustrated in FIG. 9C at the xy chromaticity coordinate of the XYZ color system. In FIGS. 10A to 10C, an x component on the horizontal axis indicates the percentage of an R component in an RGB color space. In FIGS. 10A to 10C, a y component on the vertical axis indicates the percentage of a G component in the RGB color space. When FIGS. 10A to 10C are compared with each other, the chromaticity distribution illustrated in FIG. 10C is the largest, followed by the chromaticity distribution illustrated in FIG. 10B and the chromaticity distribution illustrated in FIG. 10A in this order. This is because the color of the image captured in an imaging environment with a large amount of infrared light is close to the achromatic color and the difference among the R, G, and B values is reduced.

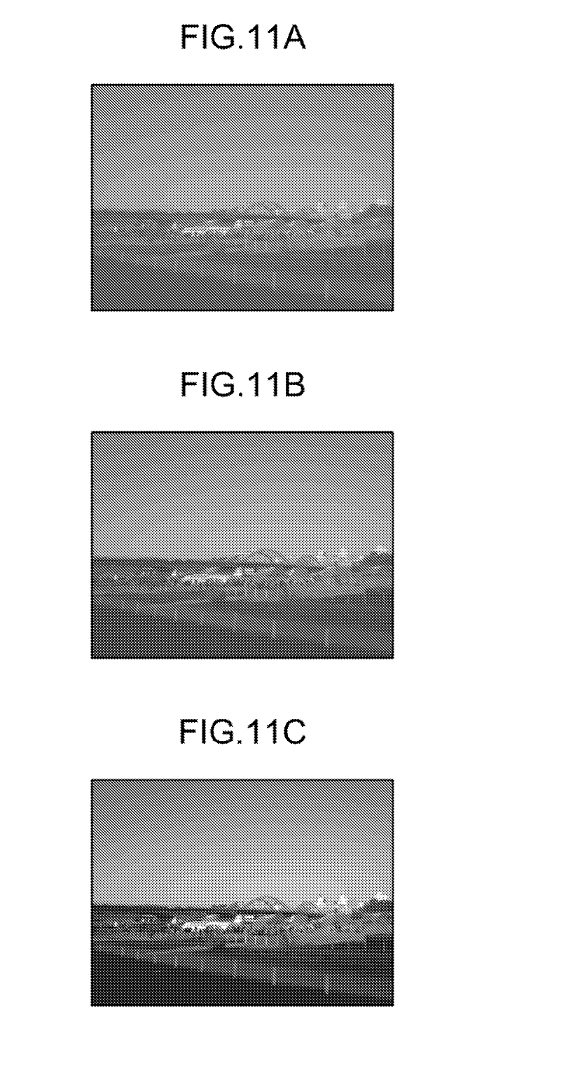

Next, a change in the color tones of the captured images of various other objects will be described. FIG. 11A is a diagram illustrating an example of the image of a river captured in the incandescent lighting environment. FIG. 11B is a diagram illustrating an example of the image of a river captured in the sunlight lighting environment. FIG. 11C is a diagram illustrating an example of the image of the river captured in the fluorescent lighting environment. In this case, as illustrated in FIG. 11A, the color of the image captured using the incandescent lamp is close to the achromatic color. As illustrated in FIG. 11C, the image captured using the fluorescent lamp is close to the image captured by the imaging apparatus with an infrared cut filter.

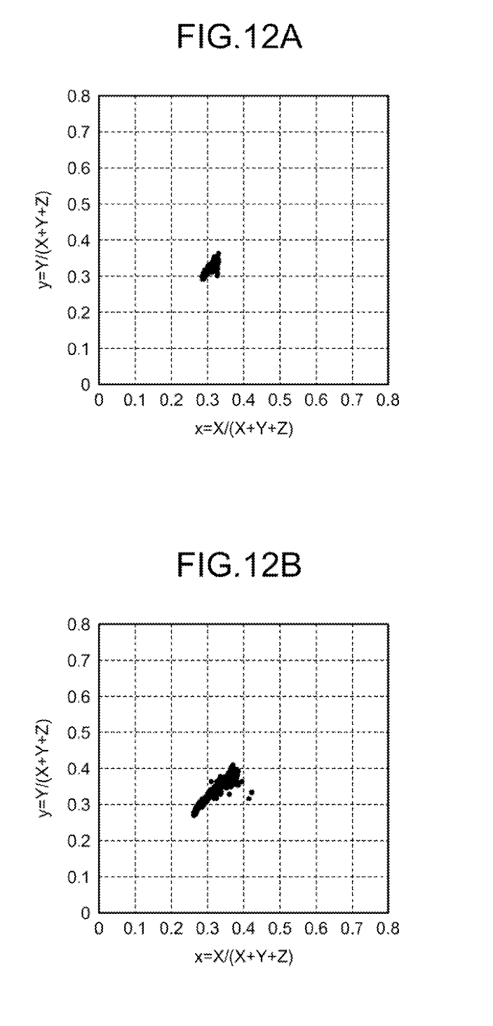

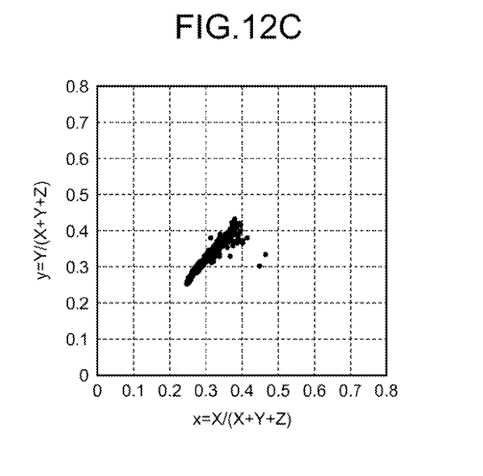

In order to clarify the difference among the color tones of the images illustrated in FIGS. 11A to 11C, the color tones are compared using the chromaticity distributions of the images illustrated in FIGS. 11A to 11C at the xy chromaticity coordinates of the XYZ color system. FIG. 12A is a graph illustrating the chromaticity distribution of the image illustrated in FIG. 11A at the xy chromaticity coordinates of the XYZ color system. FIG. 12B is a graph illustrating the chromaticity distribution of the image illustrated in FIG. 11B at the xy chromaticity coordinates of the XYZ color system. FIG. 12C is a graph illustrating the chromaticity distribution of the image illustrated in FIG. 11C at the xy chromaticity coordinate of the XYZ color system. When FIGS. 12A to 12C are compared with each other, the chromaticity distribution illustrated in FIG. 12C is the largest, followed by the chromaticity distribution illustrated in FIG. 12B and the chromaticity distribution illustrated in FIG. 12A in this order.

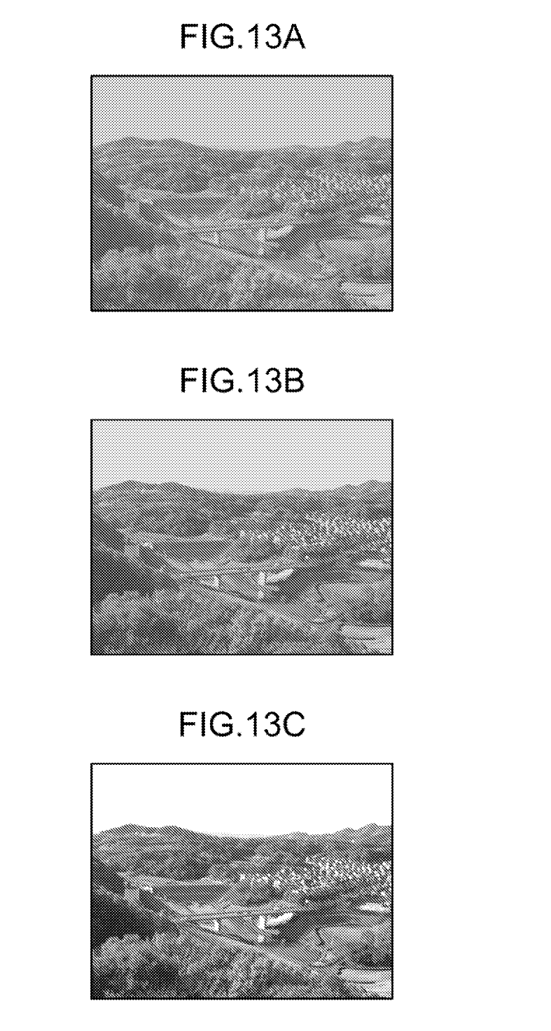

FIG. 13A is a diagram illustrating an example of an image overlooking the river which is captured in the incandescent lighting environment. FIG. 13B is a diagram illustrating an example of an image overlooking the river which is captured in the sunlight lighting environment. FIG. 13C is a diagram illustrating an example of an image overlooking the river which is captured in the fluorescent lighting environment. In this case, as illustrated in FIG. 13A, the color of the image captured using the incandescent lamp is close to the achromatic color. As illustrated in FIG. 13C, the image captured using the fluorescent lamp is close to the image captured by the imaging apparatus with an infrared cut filter.

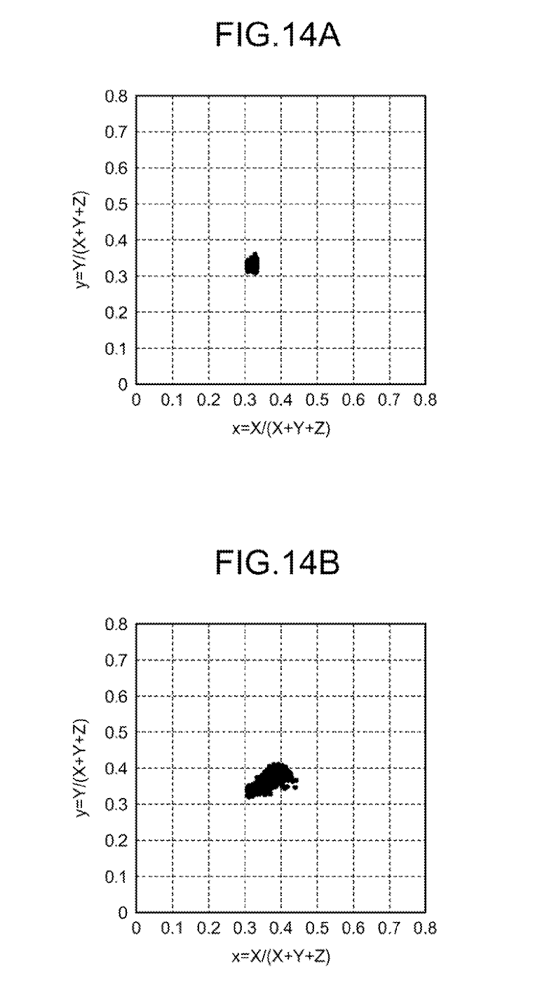

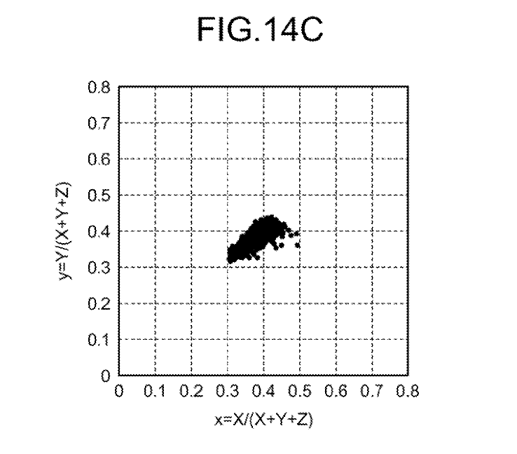

In order to clarify the difference among the color tones of the images illustrated in FIGS. 13A to 13C, the color tones are compared using the chromaticity distributions of the images illustrated in FIGS. 13A to 13C at the xy chromaticity coordinates of the XYZ color system. FIG. 14A is a graph illustrating the chromaticity distribution of the image illustrated in FIG. 13A at the xy chromaticity coordinates of the XYZ color system. FIG. 14B is a graph illustrating the chromaticity distribution of the image illustrated in FIG. 13B at the xy chromaticity coordinates of the XYZ color system. FIG. 14C is a graph illustrating the chromaticity distribution of the image illustrated in FIG. 13C at the xy chromaticity coordinate of the XYZ color system. When FIGS. 14A to 14C are compared with each other, the chromaticity distribution illustrated in FIG. 14C is the largest, followed by the chromaticity distribution illustrated in FIG. 14B and the chromaticity distribution illustrated in FIG. 14A in this order.

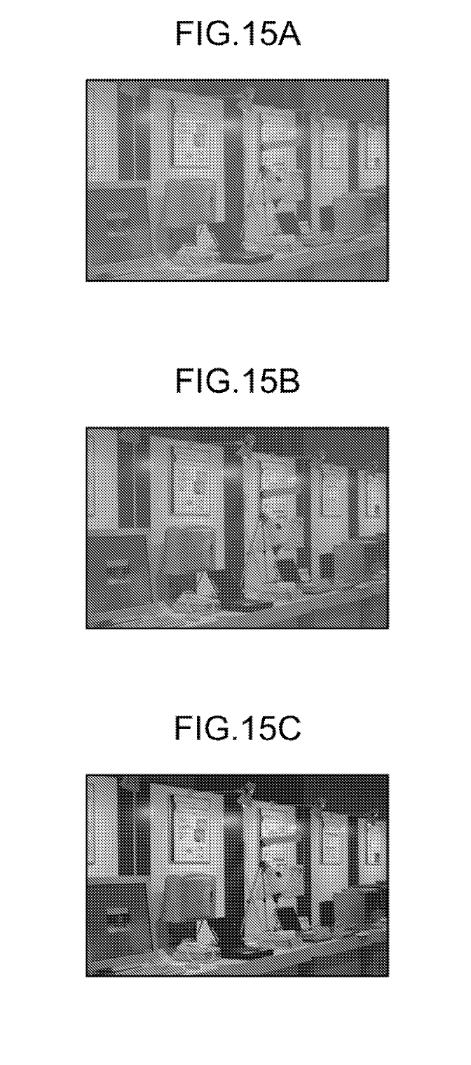

FIG. 15A is a diagram illustrating an example of the image of an indoor exhibition which is captured in the incandescent lighting environment. FIG. 15B is a diagram illustrating an example of the image of an indoor exhibition which is captured in the sunlight lighting environment. FIG. 15C is a diagram illustrating an example of the image of an indoor exhibition which is captured in the fluorescent lighting environment. In this case, as illustrated in FIG. 15A, the color of the image captured using the incandescent lamp is close to the achromatic color. As illustrated in FIG. 15C, the image captured using the fluorescent lamp is close to the image captured by the imaging apparatus with an infrared cut filter.

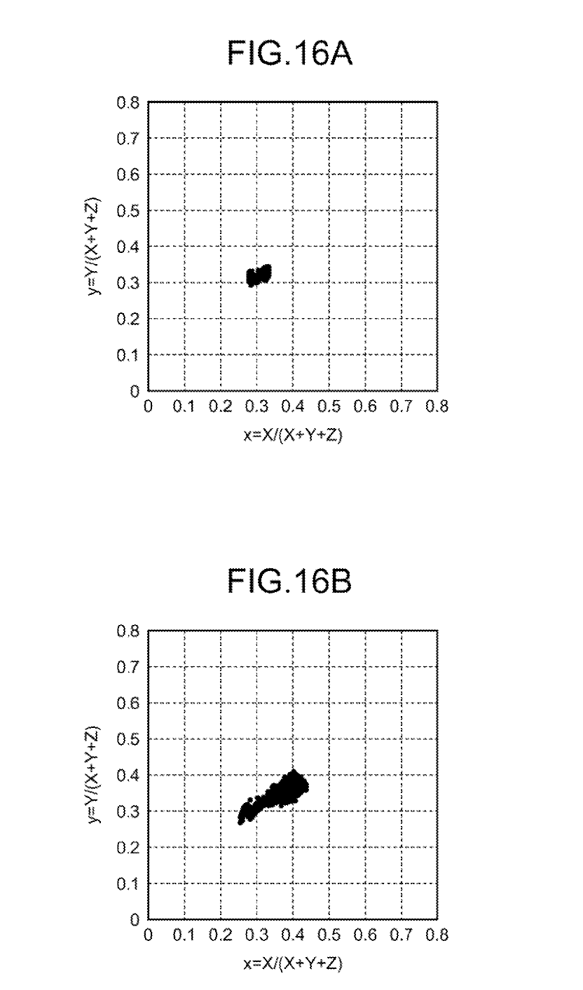

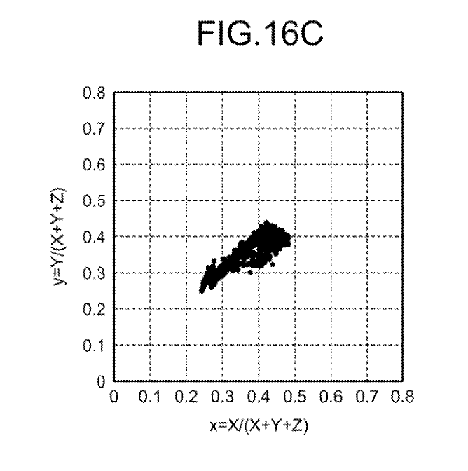

In order to clarify the difference among the color tones of the images illustrated in FIGS. 15A to 15C, the color tones are compared using the chromaticity distributions of the images illustrated in FIGS. 15A to 15C at the xy chromaticity coordinates of the XYZ color system. FIG. 16A is a graph illustrating the chromaticity distribution of the image illustrated in FIG. 15A at the xy chromaticity coordinates of the XYZ color system. FIG. 16B is a graph illustrating the chromaticity distribution of the image illustrated in FIG. 15B at the xy chromaticity coordinates of the XYZ color system. FIG. 16C is a graph illustrating the chromaticity distribution of the image illustrated in FIG. 15C at the xy chromaticity coordinate of the XYZ color system. When FIGS. 16A to 16C are compared with each other, the chromaticity distribution illustrated in FIG. 16C is the largest, followed by the chromaticity distribution illustrated in FIG. 16B and the chromaticity distribution illustrated in FIG. 16A in this order.

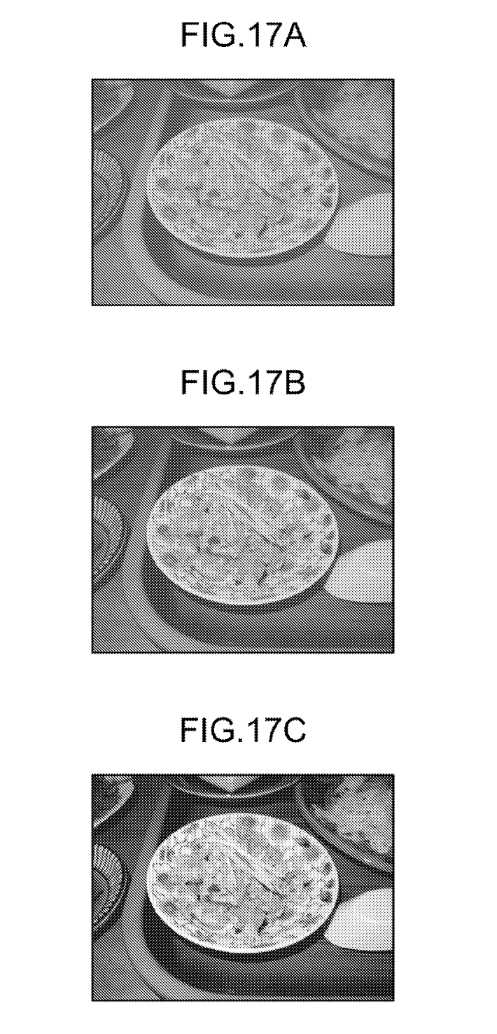

FIG. 17A is a diagram illustrating an example of the image of food on the dish which is captured in an incandescent lighting environment. FIG. 17B is a diagram illustrating an example of the image of the food on the dish which is captured in the sunlight lighting environment. FIG. 17C is a diagram illustrating an example of the image of the food on the dish which is captured in the fluorescent light environment. In this case, as illustrated in FIG. 17A, the color of the image using the incandescent lamp is close to the achromatic color. As illustrated in FIG. 17C, the image captured using the fluorescent lamp is close to the image captured by the imaging apparatus with an infrared cut filter.

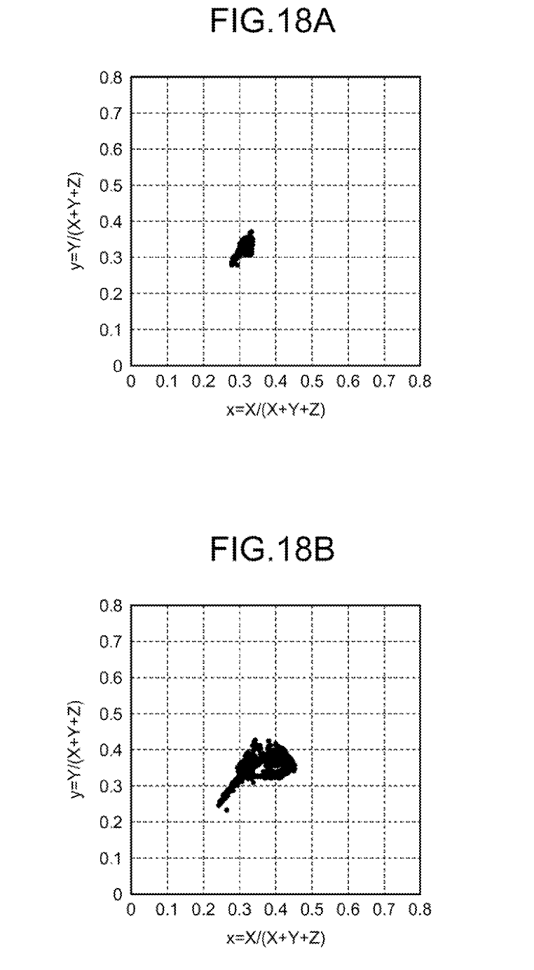

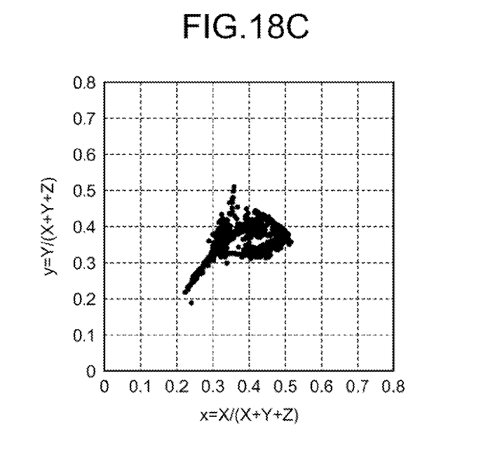

In order to clarify the difference among the color tones of the images illustrated in FIGS. 17A to 17C, the color tones are compared using the chromaticity distributions of the images illustrated in FIGS. 17A to 17C at the xy chromaticity coordinates of the XYZ color system. FIG. 18A is a graph illustrating the chromaticity distribution of the image illustrated in FIG. 17A at the xy chromaticity coordinates of the XYZ color system. FIG. 18B is a graph illustrating the chromaticity distribution of the image illustrated in FIG. 17B at the xy chromaticity coordinates of the XYZ color system. FIG. 18C is a graph illustrating the chromaticity distribution of the image illustrated in FIG. 17C at the xy chromaticity coordinate of the XYZ color system. When FIGS. 18A to 18C are compared with each other, the chromaticity distribution illustrated in FIG. 18C is the largest, followed by the chromaticity distribution illustrated in FIG. 18B and the chromaticity distribution illustrated in FIG. 18A in this order.

As such, in the captured images, there is a significant difference in the range of the chromaticity distribution due to a difference in the lighting environment during an imaging operation, that is, a difference in the amount of near-infrared light mixed. The color of the image captured using the incandescent lamp is close to the achromatic color and the color tone of the image is reduced. Therefore, the image captured using the incandescent lamp has the smallest chromaticity distribution. The color of the image captured using the fluorescent lamp is closest to the chromatic color and the color tone of the image increases. Therefore, the image captured using the fluorescent lamp has the largest chromaticity distribution. The image captured using sunlight has a chromaticity distribution there between. Therefore, when a feature amount indicating the range of the chromaticity distribution of the color of each pixel in the captured image can be derived, it is possible to estimate a lighting environment during imaging from the feature amount. Examples of the feature amount include the maximum value, minimum value, and standard deviation of the chromaticity distribution.

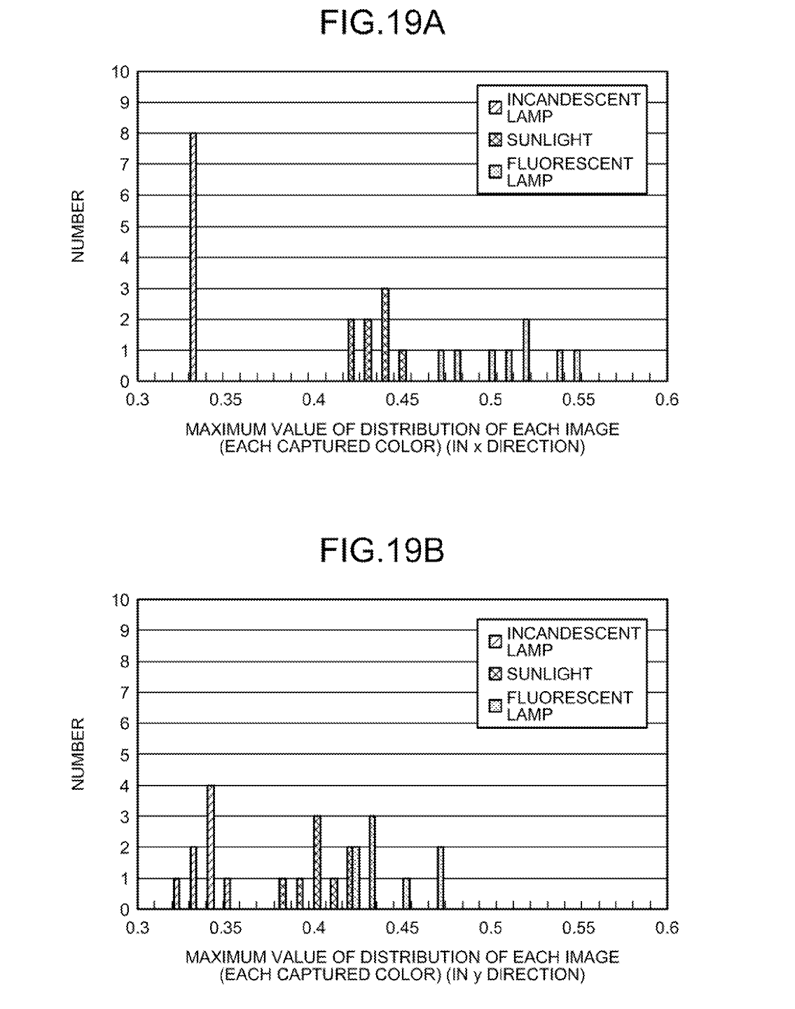

FIG. 19A is a histogram illustrating the maximum value of the chromaticity distribution in the x direction for each type of light source. The example illustrated in FIG. 19A is a histogram illustrating the maximum value of the chromaticity distribution in the x direction for each type of light source in the images illustrated in FIGS. 10A to 10C, FIGS. 12A to 12C, FIGS. 14A to 14C, FIGS. 16A to 16C, and FIGS. 18A to 18C, and other images (not illustrated). FIG. 19B is a histogram illustrating the maximum value of the chromaticity distribution in the y direction for each type of light source. The example illustrated in FIG. 19B is a histogram illustrating the maximum value of the chromaticity distribution in the y direction for each type of light source in the images illustrated in FIGS. 10A to 10C, FIGS. 12A to 12C, FIGS. 14A to 14C, FIGS. 16A to 16C, and FIGS. 18A to 18C, and other images (not illustrated). As illustrated in FIGS. 19A and 19B, the distribution of the maximum value in the histogram varies depending on the type of light source. In this embodiment, a lighting environment during imaging is estimated using the maximum value of the chromaticity distribution in the x direction.

Returning to FIG. 1, the deriving unit 12 derives various values. For example, the deriving unit 12 derives the maximum value of the chromaticity distribution in the x direction which indicates the range of the chromaticity distribution when the chromaticity distribution of the color of each pixel in the image captured by the imaging unit 11 is calculated.

the estimating unit 13 estimates a lighting environment during imaging. For example, the estimating unit 13 estimates the lighting environment during imaging based on the maximum value of the chromaticity distribution in the x direction which is derived by the deriving unit 12.

as illustrated in FIG. 19A, the distribution of the histogram of the maximum value of the chromaticity distribution in the x direction varies depending on the type of light source. Therefore, a threshold value may be appropriately determined to distinguish the type of light source from the maximum value of the chromaticity distribution in the x direction. In this embodiment, two threshold values T1 and T2 are used to estimate the lighting environment during imaging. For example, the threshold value T1 is set to a value which is regarded as the boundary between the histogram in the incandescent lighting environment and the histogram in the sunlight lighting environment. The threshold value T2 is set to, for example, a value which is regarded as the boundary between the histogram in the sunlight lighting environment and the histogram in the fluorescent lighting environment.

when the maximum value of the chromaticity distribution in the x direction which is derived by the deriving unit 12 is less than the threshold value T1, the estimating unit 13 estimates that the lighting environment during imaging is the incandescent lamp. When the maximum value of the chromaticity distribution in the x direction is equal to or greater than the threshold value T1 and is less than the threshold value T2, the estimating unit 13 estimates that the lighting environment during imaging is sunlight. When the maximum value of the chromaticity distribution in the x direction is equal to or greater than the threshold value T2, the estimating unit 13 estimates that the lighting environment during imaging is the fluorescent lamp.

The storage unit 14 stores various kinds of information. For example, the storage unit 14 stores color correction information 14a for each lighting environment. An example of the storage unit 14 is a data rewritable semiconductor memory, such as a flash memory or an NVSRAM (Non Volatile Static Random Access Memory).

Next, the correction information 14a will be described. Values indicating the R, G, and B colors of each pixel are represented by a 3-by-1 matrix. For each lighting environment, as the correction information 14a, a correction coefficient A for correcting the color S of each pixel before correction to a color which is close to the color T of each pixel captured by the imaging apparatus with an infrared cut filter is represented by a 3×3 matrix illustrated in the following Expression 1.

$$A = [ \begin{matrix}α r & α g & α b \\ β r & β g & β b \\ γ r & γ g & γ b\end{matrix} ] \qquad ( 1 )$$

The color T after correction is represented by the product of the color S before correction and the correction coefficient A, as illustrated in the following Expression 2:

T=A·S (2)

Since the color of the image captured using the incandescent lamp is closer to the achromatic color than that of the image captured using the fluorescent lamp, a change in the color tone of the image captured using the incandescent lamp needs to be more than a change in the color tone of the image captured using the fluorescent lamp. Therefore, the value of an element in the correction coefficient A for the incandescent lamp is greater than the value of an element in the correction coefficient A for the fluorescent lamp. For example, a light source in which the incandescent lamp with a large amount of infrared light and the fluorescent lamp with a small amount of infrared light are mixed with the same brightness has a medium amount of infrared light and is close to the chromaticity distribution of sunlight.

In this embodiment, the storage unit 14 stores the correction coefficient A corresponding to the incandescent lamp and the correction coefficient A corresponding to the fluorescent lamp as the correction information 14a for each lighting environment.

The generating unit 15 reads the correction coefficient A corresponding to the lighting environment which is estimated by the estimating unit 13 from the storage unit 14 and outputs the correction coefficient A to the correcting unit 16. For example, when it is estimated that the lighting environment is the incandescent lamp, the generating unit 15 reads the correction coefficient A corresponding to the incandescent lamp from the storage unit 14 and outputs the correction coefficient A to the correcting unit 16. There is little change in the color tone of the image captured using the fluorescent lamp and the image captured using the fluorescent lamp is close to the image captured by the imaging apparatus with an infrared cut filter. Therefore, in this embodiment, when it is estimated that the lighting environment is the fluorescent lamp, color correction is not performed. When it is estimated that the lighting environment is the fluorescent lamp, the generating unit 15 does not particularly output the correction coefficient to the correcting unit 16. Even when the lighting environment is the fluorescent lamp, color correction may be performed. In this case, the generating unit 15 reads the correction coefficient A corresponding to the fluorescent lamp from the storage unit 14 and outputs the correction coefficient A to the correcting unit 16.

When the correction information 14a corresponding to the lighting environment which is estimated by the estimating unit 13 is not stored in the storage unit 14, the generating unit 15 generates the correction information 14a corresponding to the estimated lighting environment from the correction information 14a for each lighting environment which is stored in the storage unit 14 using interpolation. For example, when it is estimated that the lighting environment is sunlight, the generating unit 15 reads the correction coefficient A corresponding to the incandescent lamp and the correction coefficient A corresponding to the fluorescent lamp from the storage unit 14. Then, the generating unit 15 performs linear interpolation for each corresponding element of the correction coefficient A corresponding to the incandescent lamp and the correction coefficient A corresponding to the fluorescent lamp to generate a correction coefficient A corresponding to sunlight and outputs the generated correction coefficient A to the correcting unit 16.

When the correction coefficient A is input from the generating unit 15, the correcting unit 16 corrects the color of the image captured by the imaging unit 11 using the input correction coefficient A. Then, the correcting unit 16 outputs image information to the gamma correction unit 17. For example, the correcting unit 16 performs calculation represented by the above-mentioned Expression 2 for each pixel of the image captured by the imaging unit 11 using the R, G, and B values of the pixel as S, thereby calculating R, G, and B pixel values T after correction.

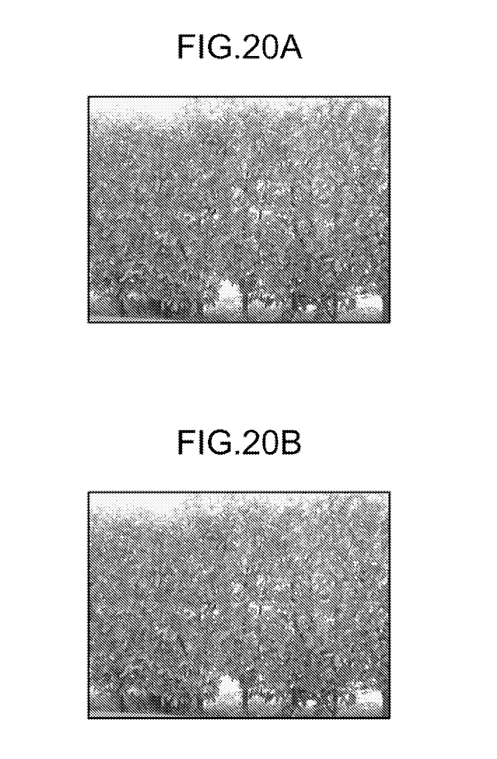

Next, an example of the correction result of the image by the correcting unit 16 will be described. FIG. 20A is a diagram illustrating an example of the correction result of the image illustrated in FIG. 9A with the correction coefficient corresponding to the incandescent lamp. FIG. 20B is a diagram illustrating an example of the correction result of the image illustrated in FIG. 9B with the correction coefficient corresponding to sunlight. As illustrated in FIGS. 20A and 20B, the image captured in each lighting environment is corrected to an image close to the image captured using the fluorescent lamp which is illustrated in FIG. 9C by the above-mentioned correction process.

The gamma correction unit 17 performs non-linear gamma correction for correcting the sensitivity characteristics of the imaging unit 11 on the image information input from the correcting unit 16 such that a variation in the brightness of the image captured by the imaging unit 11 is proportional to a variation in the pixel value.

The image quality adjusting unit 18 performs various kinds of image processing for adjusting image quality. For example, the image quality adjusting unit 18 performs predetermined image processing on the image information such that the saturation or contrast of the image indicated by the image information which has been subjected to gamma correction by the gamma correction unit 17 has a predetermined value.

The output unit 19 outputs various kinds of information. For example, the output unit 19 displays the image whose quality is adjusted by the image quality adjusting unit 18. An example of the output unit 19 is an LCD (Liquid Crystal Display) display device. The output unit 19 may output the image information in which image quality is adjusted by the image quality adjusting unit 18 to the outside.

The memory card 20 stores various kinds of information. For example, the memory card 20 stores the image information in which image quality is adjusted by the image quality adjusting unit 18.

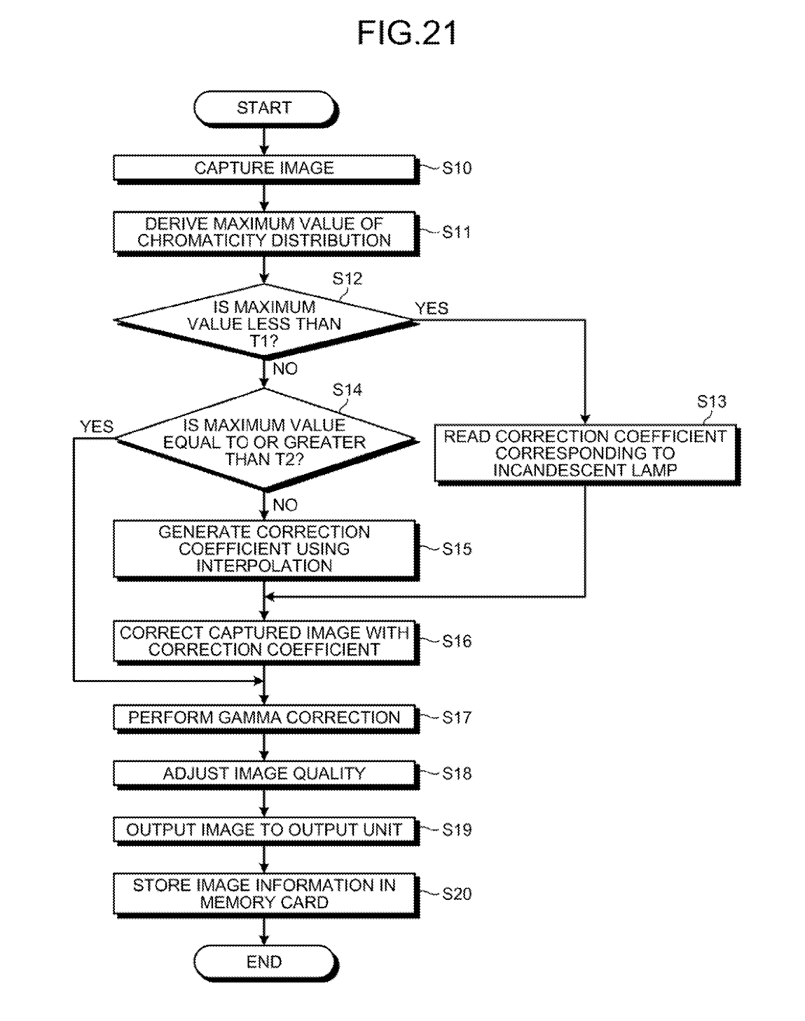

Next, the flow of a process when the imaging apparatus 10 according to this embodiment captures an image will be described. FIG. 21 is a flowchart illustrating the procedure of an imaging process. For example, the imaging process is performed at the time when a predetermined operation for instructing the imaging apparatus 10 to capture an image is operated.

As illustrated in FIG. 21, the imaging unit 11 reads analog signals from each pixel of the imaging element, performs various kinds of analog signal processing and digital signal processing, and outputs image information indicating the captured image (Step S10). The deriving unit 12 derives the maximum value of the chromaticity distribution of the image captured by the imaging unit 11 in the x direction (Step S11). The estimating unit 13 determines whether the derived maximum value of the chromaticity distribution in the x direction is less than the threshold value T1 (Step S12). When the maximum value is less than the threshold value T1 (Yes in Step S12), the generating unit 15 reads the correction coefficient A corresponding to the incandescent lamp from the storage unit 14 and outputs the correction coefficient A to the correcting unit 16 (Step S13). On the other hand, when the maximum value is not less than the threshold value T1 (No in Step S12), the estimating unit 13 determines whether the maximum value is equal to or greater than the threshold value T2 (Step S14). When the maximum value is equal to or greater than the threshold value T2 (Yes in Step S14), the process proceeds to Step S17, which will be described below. On the other hand, when the maximum value is not equal to or greater than the threshold value T2 (No in Step S14), the generating unit 15 generates the correction coefficient A corresponding to sunlight from the correction coefficient A corresponding to the incandescent lamp and the correction coefficient A corresponding to the fluorescent lamp using interpolation and outputs the generated correction coefficient A to the correcting unit 16 (Step S15).

The correcting unit 16 corrects the color of the image captured by the imaging unit 11 with the correction coefficient A input from the generating unit 15 (Step S16). The gamma correction unit 17 performs gamma correction on the image information (Step S17). The image quality adjusting unit 18 performs predetermined image processing for adjusting image quality on the image information subjected to the gamma correction (Step S18). The image quality adjusting unit 18 outputs the image whose quality is adjusted to the output unit 19 such that the output unit 19 displays the image (Step S19). In addition, the image quality adjusting unit 18 stores the image information in which image quality is adjusted in the memory card 20 (Step S20) and ends the process.

As such, the imaging apparatus 10 captures an image using the imaging unit 11 which has sensitivity to visible light and infrared light. In addition, the imaging apparatus 10 derives the maximum value of the chromaticity distribution of the image in the x direction. Then, the imaging apparatus 10 estimates the lighting environment during imaging based on the maximum value of the chromaticity distribution in the x direction. In this way, according to the imaging apparatus 10, it is possible to accurately estimate the lighting environment during imaging from the captured image.

In addition, the imaging apparatus 10 stores the color correction information 14a for each lighting environment. Then, the imaging apparatus 10 corrects the captured image using the correction information 14a corresponding to the estimated lighting environment among the stored correction information 14a for each lighting environment. In this way, according to the imaging apparatus 10, it is possible to correct the captured image to an appropriate image with sufficient color reproducibility even when the lighting environments are different from each other.

When there is no correction information 14a corresponding to the estimated lighting environment, the imaging apparatus 10 generates correction information for the estimated lighting environment from the correction information 14a for other lighting environments using interpolation. Then, the imaging apparatus 10 corrects the captured image with the generated correction information. In this way, according to the imaging apparatus 10, it is possible to correct the captured image to an appropriate image even when all of the correction information items for each lighting environment are not stored.

### [b] Second Embodiment

The apparatus according to the first embodiment has been described above. However, the invention is not limited to the above-described embodiment, but various other embodiments may be made. Hereinafter, another embodiment of the invention will be described.

For example, in the first embodiment, the maximum value of the chromaticity distribution in the x direction is used as the feature amount indicating the range of the chromaticity distribution, but the invention is not limited thereto. For example, the feature amount may be the maximum value in the y direction. In addition, the feature amount may be other values, such as the minimum value of the chromaticity distribution in the x direction or the y direction or a standard deviation.

For example, in some cases, pluralities of light sources are mixed with each other. For example, as the lighting environments, the incandescent lamp and sunlight are mixed with each other. For example, the following method may be used. The feature amount with the largest chromaticity distribution in each lighting environment is stored as a peak value. Then, the feature amount of the chromaticity distribution of the captured image is calculated. The feature amount is set such that, as it is closer to the peak value, the percentage is increased. Correction information is generated from the correction information 14a for each lighting environment by interpolation. In this way, even when pluralities of lighting environments are mixed with each other, it is possible to correct the captured image to an appropriate image.

In the above-described embodiment, as the correction information 14a, the correction coefficient A corresponding to the incandescent lamp and the correction coefficient A corresponding to the fluorescent lamp are stored in the storage unit 14 and the correction coefficient corresponding to sunlight is generated by interpolation. However, the invention is not limited thereto. For example, the correction coefficient A corresponding to sunlight may also be stored in the storage unit 14 and the image captured in a sunlight lighting environment may be corrected using the correction coefficient A corresponding to sunlight which is stored in the storage unit 14.

In the above-described embodiment, the correction coefficient A is stored as the correction information 14a. However, the invention is not limited thereto. For example, a lookup table may be stored as the correction information 14a for each lighting environment. The lookup tables may be generated for all colors and color conversion may be performed. In addition, the lookup table may be generated only for a specific color and color conversion may be performed on colors other than the specific color using interpolation from the specific color.

In the above-described embodiment, the imaging apparatus 10 performs color correction in correspondence with the lighting environment. However, the invention is not limited thereto. For example, information about the image captured by the imaging apparatus 10 may be stored in an image processing apparatus, such as a computer, and the image processing apparatus may estimate the lighting environment from the image and perform color correction in correspondence with the estimated lighting environment.

The drawings illustrate the conceptual function of each component of each apparatus, but each component is not necessarily physically configured as illustrated in the drawings. That is, the detailed state of the division and integration of each apparatus is not limited to that illustrated in the drawings, but a portion of or the entire apparatus may be functionally or physically divided or integrated in an arbitrary unit according to various kinds of loads or use conditions. For example, the processing units of the imaging apparatus 10, such as the deriving unit 12, the estimating unit 13, the generating unit 15, the correcting unit 16, the gamma correction unit 17, and the image quality adjusting unit 18 may be appropriately integrated with each other. In addition, the process of each processing unit may be appropriately divided into the processes of a plurality of processing unit. In addition, a portion of or the entire processing function of each processing unit may be implemented by a CPU and a program which is analyzed and executed by the CPU, or it may be implemented as hardware by wired logic.

Image Processing Program

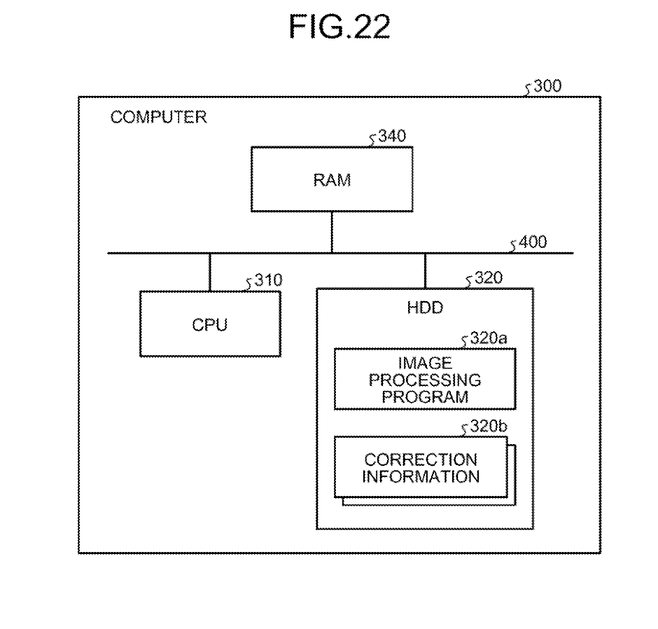

A computer system, such as a personal computer or a workstation, may execute a program which is prepared in advance to implement various kinds of processes according to the above-described embodiments. Next, an example of a computer system which executes a program with the same functions as those in the above-described embodiments will be described. FIG. 22 is a diagram illustrating the computer which executes an image processing program.

As illustrated in FIG. 22, a computer 300 includes a CPU (Central Processing Unit) 310, an HDD (Hard Disk Drive) 320, and a RAM (Random Access Memory) 340. The units 300 to 340 are connected to each other through a bus 400.

The HDD 320 stores an image processing program 320a for implementing the same functions as those of the deriving unit 12, the estimating unit 13, the generating unit 15, and the correcting unit 16 of the imaging apparatus 10 in advance. The image processing program 320a may be appropriately divided.

In addition, the HDD 320 stores various kinds of information. For example, the HDD 320 stores correction information 320b corresponding to the correction information 14a illustrated in FIG. 1.

The CPU 310 reads the image processing program 320a from the HDD 320, develops the image processing program 320a on the RAM 340, and performs each process using the correction information 320b stored in the HDD 320. That is, the image processing program 320a performs the same operations as those of the deriving unit 12, the estimating unit 13, the generating unit 15, and the correcting unit 16.

The image processing program 320a is not necessarily stored in the HDD 320 at the beginning.

For example, the program is stored in a “portable physical medium”, such as a flexible disk (FD), a CD-ROM, a DVD disk, a magneto-optical disk, or an IC card inserted into the computer 300. Then, the computer 300 may read the program from the portable physical medium and execute the program.

The program is stored in, for example, “another computer (or server)” which is connected to the computer 300 through a public line, the Internet, a LAN, or a WAN. Then, the computer 300 may read the program from the other computer and execute the program.

An imaging apparatus according to an aspect of the invention can accurately estimate a lighting environment during imaging from a captured image.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An imaging apparatus comprising:
an imaging unit that has sensitivity to visible light and infrared light and captures an image;
a deriving unit that, when a distribution of a color of each pixel in the image captured by the imaging unit is calculated, derives a predetermined feature amount indicating a range of the color distribution; and
an estimating unit that estimates a lighting environment during imaging based on the feature amount derived by the deriving unit.

2. The imaging apparatus according to claim 1, wherein the deriving unit derives at least one of a maximum value, a minimum value, and a standard deviation of the color distribution as the feature amount.

3. The imaging apparatus according to claim 1, wherein the deriving unit derives the feature amount indicating the range of a chromaticity distribution of the color of each pixel in the captured image at xy chromaticity coordinates of an XYZ color system.

4. The imaging apparatus according to claim 1 further comprising
a storage unit that stores color correction information for each lighting environment and a correcting unit that corrects the image captured by the imaging unit using the color correction information corresponding to the lighting environment estimated by the estimating unit, among the color correction information stored in the storage unit.

5. The imaging apparatus according to claim 4 further comprising
a generating unit that, when the color correction information corresponding to the lighting environment estimated by the estimating unit is not stored in the storage unit, generates the color correction information corresponding to the estimated lighting environment from the color correction information stored in the storage unit using interpolation, wherein
the correcting unit corrects, when the color correction information corresponding to the lighting environment estimated by the estimating unit is not stored in the storage unit, the image captured by the imaging unit using the color correction information generated by the generating unit.

6. An image processing apparatus comprising:
a deriving unit that, when a distribution of a color of each pixel in an image captured by an imaging apparatus which has sensitivity to visible light and infrared light is calculated, derives a predetermined feature amount indicating a range of the color distribution; and
an estimating unit that estimates a lighting environment during imaging based on the feature amount derived by the deriving unit.

7. The image processing apparatus according to claim 6, wherein the deriving unit derives at least one of a maximum value, a minimum value, and a standard deviation of the color distribution as the feature amount.

8. The image processing apparatus according to claim 6, wherein the deriving unit derives the feature amount indicating the range of a chromaticity distribution of the color of each pixel in the captured image at xy chromaticity coordinates of an XYZ color system.

9. The image processing apparatus according to claim 6 further comprising
a storage unit that stores color correction information for each lighting environment and
a correcting unit that corrects the image captured by the imaging apparatus using the color correction information corresponding to the lighting environment estimated by the estimating unit, among the color correction information stored in the storage unit.

10. The image processing apparatus according to claim 9 further comprising
a generating unit that, when the color correction information corresponding to the lighting environment estimated by the estimating unit is not stored in the storage unit, generates the color correction information corresponding to the estimated lighting environment from the color correction information stored in the storage unit using interpolation, wherein
the correcting unit corrects, when the color correction information corresponding to the lighting environment estimated by the estimating unit is not stored in the storage unit, the image captured by the imaging apparatus using the color correction information generated by the generating unit.

11. A computer-readable storage medium having stored therein a program for causing a computer to execute a process for processing an image, the process comprising:
deriving a predetermined feature amount indicating the range of a color distribution when a distribution of a color of each pixel in an image captured by an imaging unit that has sensitivity to visible light and infrared light is calculated; and
estimating a lighting environment during imaging based on the derived feature amount.

12. The computer-readable recording medium according to claim 11, wherein the deriving derives at least one of a maximum value, a minimum value, and a standard deviation of the color distribution as the feature amount.

13. The computer-readable recording medium according to claim 11, wherein the deriving derives the feature amount indicating the range of a chromaticity distribution of the color of each pixel in the captured image at xy chromaticity coordinates of an XYZ color system.

14. The computer-readable recording medium according to claim 11, wherein the process further comprising:
correcting the image captured by the imaging unit using color correction information corresponding to the estimated lighting environment, among color correction information for each lighting environment stored in a storage unit that stores the color correction information for each lighting environment.

15. The computer-readable recording medium according to claim 14, wherein the process further comprising:
generating the color correction information corresponding to the estimated lighting environment from the color correction information stored in the storage unit using interpolation when the color correction information corresponding to the estimated lighting environment is not stored in the storage unit, and
the correcting corrects the image captured by the imaging unit using the generated color correction information when the color correction information corresponding to the estimated lighting environment is not stored in the storage unit.
